(19) United States
(12) Patent Application Publication
(10) Pub. No.: US 2013/0106389 A1
(43) Pub. Date: May 2, 2013

(54) LOW POWER HIGH PSRR PVT COMPENSATED BANDGAP AND CURRENT REFERENCE WITH INTERNAL RESISTOR WITH DETECTION/MONITORING CIRCUITS

(71) Applicant: Dillip Kumar Routray, Hyderabad (IN)

(72) Inventor: Dillip Kumar Routray, Hyderabad (IN)

(21) Appl. No.: 13/284,833

(22) Filed: Oct. 28, 2011

(51) Int. Cl. G05F 3/16

(52) U.S. Cl. 323/313

(57) ABSTRACT

A system for generating a high PSRR bandgap and current reference that includes a bandgap reference circuit for generating a first input and generating a bandgap reference voltage output. A current reference circuit for receiving a second input and generating a reference current. An internal resistor coupled to the first input from bandgap reference circuit and second input of the current reference circuit, wherein the current generated proportional to first input and the second input are generated as a function of the internal resistor. The system also includes a detection/monitoring circuit for bandgap reference output.

### TECHNICAL FIELD

The present disclosure pertains generally to bandgap and current reference circuits, and more particularly to a combined bandgap and current reference with an internal resistor and process-voltage-temperature (PVT) compensation.

### BACKGROUND OF THE INVENTION

Bandgap voltage reference circuits and current reference circuits are known in the art as discrete independent circuits. In applications where a bandgap voltage reference circuit and current reference circuit are both used, they are thus used as separate circuits, which increases the circuit area, power requirements, and other design parameters that increase the expense of the circuit.

### SUMMARY OF THE INVENTION

A system for generating a bandgap and current reference is disclosed that includes a bandgap reference circuit for generating a bandgap reference voltage output, and also for generating a proportional first input. A current reference circuit receives a second input and generates a reference current. An internal resistor is used by the bandgap reference circuit and the current reference circuit, which reduces the expense of having an off-chip resistor.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for providing a low power bandgap with current reference in a bandgap voltage detection circuit, in accordance with an exemplary embodiment of the present disclosure;

FIG. 2 is a diagram of a circuit for generating a bandgap reference in accordance with an exemplary embodiment of the present disclosure;

FIG. 3 is a diagram of a circuit for generating a current reference in accordance with an exemplary embodiment of the present disclosure;

FIG. 4 is a diagram of a detection/monitoring circuit for detecting the bandgap output and the bias current proportional to bandgap output VBG_OUT in accordance with an exemplary embodiment of the present disclosure; and

FIG. 5 is a diagram of an operational amplifier with chopper stabilization for low noise in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

A very low power bandgap and current reference (nominal 0.12 mW, 1.8 V) is disclosed. The disclosed embodiment has an internal resistor R_{PP} (p+ polysilicon resistor) and is implemented in CSM 180 nm process technology, which eliminates the need for using an external reference resistor for constant current generation. The absolute value of R_{PP} may vary by +/−25% across common process-voltage-temperature (PVT) variations. The current obtained through the resistor will also vary +/−25% across PVT variations for a fixed constant voltage. The present low power bandgap and current reference will keep current variations within +/−5% across PVT variations (from −20 to −100 deg C.) with the same internal resistor variations (+/−25%)

Additionally, the current disclosure can also provide a very high (80 dB) DC power supply rejection ratio (“PSRR”) and with up to 35 dB through 25 KHz. The disclosed low power bandgap and current reference can use chopper stabilization techniques for improved bandgap output noise (35 uV within audio frequency range) with a bandgap output variation of less than 0.5% across PVT variations.

The disclosed bandgap with current reference uses a low voltage topology bandgap, with a low power operational amplifier that draws approximately 10 uA of current. Due to low differential amplifier current, the transconductance of the input stage is low. The operational amplifier noise properties are dominated by white noise at higher frequencies. The input differential amplifier transconductance is maintained according to white noise and a PSRR within the audio frequency range. The 1/f noise is reduced by using a chopping circuit (with negligible power), and the 100 KHz chopper clock is used for the operational amplifier to achieve an integrated output noise of 35 uV RMS within a 30 KHz band. The minimum PSRR of 80 dB at DC operation and a PSRR of 37 dB at 25 KHz is achieved by using a high open-loop gain (90 dB) for the operational amplifier, as well as overall bandgap design.

The reference current variation resulting from process corners and resistor variation is minimized through the adjustment of K′ (“μCox”) and the threshold voltage (“V_{T}”) across corners and taking the advantage of the inverse relationship between them. The reference current variation with temperature due to resistor variation is also achieved by utilizing the relationship between mobility (μ) and the threshold voltage (V_{T}).

The bandgap architecture employs a chopper stabilization technique for the operational amplifier to reduce the overall noise at the current outputs. It uses very low power operational amplifier, with transistors operating in their sub-threshold region. The current reference circuit uses an internal resistor to generate currents and is rendered independent of process and temperature variations. The reference current is rendered independent of process variations by exploiting the physical relationship between the threshold voltage V_{TH} & μCox across various process corners. Also the power supply and temperature compensation is achieved by a proportional to absolute temperature (“PTAT”) reference which helps in generation of process independent reference current. The low frequency power supply rejection ratio is increased by PSRR boost principles. The very low bandgap output noise is achieved with a chopper stabilized operational amplifier.

The supply independent current reference is obtained by generating a I_{PTAT} current obtained:

IPTAT=(VBE2−VBE1)/R1

The bandgap output is obtained as follows:

VBG_OUT=VBE2+(I_{PTAT}*R2)=VBE2+R2/R1*(VBE2−VBE1)

By choosing the emitter area ratios for the BJTs for VBE1 & VBE2 to be 1:8, a supply independent bandgap output with PTAT current is obtained.

The Process compensation principle is explained as follows:

If V_{GS-REF}=2*V_{GSP}, then I_{REF} can be expressed as Equation (1):

$$\begin{matrix}{I}_{REF} = μ Cox ( Wref / ( 2 {L}_{REF} ) ) {( 2 * {V}_{GSP} - {V}_{TP} )}^{2} \\ = μ Cox ( Wref / ( 2 * {L}_{REF} ) ) {( {V}_{TP} + 2 * √ 2 Ip / μ Cox ( Wp / Lp ) )}^{2}\end{matrix}$$

where V_{GS-REF} is obtained as cascade of two PMOS transistors with W_{P}/L_{P} with current Ip. If the current Ip is being obtained from a PMOS transistor (W_{P1}/L_{P1}) with a NMOS current mirror, then the I_{REF} can be expressed as Equation (2)

I_{REF}=μCox*(W_{REF}/2*L_{REF}))*[(1−2*((W_{P1}/L_{P1})/(W_{P}/L_{P}))^{0.5})*(V_{TP})+2(((W_{P1}/L_{P1})/(W_{P}/L_{P}))*(V_{GSP1})]

Differentiating I_{REF} with respect to μCox and equating to 0 for the reference current to be process compensated yields Equation (3):

μCox/μCox_{NOM}[(1−2*((W_{P1}/L_{P1})/(W_{P}/L_{P}))^{0.5})*V_{TP-NOM}+2*((W_{P1}/L_{P1})/(W_{P}/L_{P}))^{0.5}*V_{GSP1}]/[(1−2((W_{P1}/L_{P1})/(W_{P}/L_{P}))^{0.5}*V_{TP}+2((W_{P1}/L_{P1})/(W_{P}/L_{P}))^{0.5}*(V_{GSP1}))]

μCox_{NOM} & V_{TP-NOM} are the nominal values for μCox and V_{TP}, i.e., without any process variations. The calculated values for μCox and V_{TP} match with the simulation results. For a given current, the ratio W_{P1}/L_{P1} can be calculated by keeping V_{GSP1}=2*V_{TP-NOM} and with V_{TP-NOM}. Similarly, for any two corners (Typ.,SS & Typ.,FF), the ratio W_{P}/L_{P} can be calculated as Equation (4):

W_{P}/L_{P}=4*(W_{P1}/L_{P1})*[1+(((μCoxSS)/(μCoxTyp))^{0.5}−1)]*V_{GSP1}/{Vtpnom−((μCoxSS)/(μCoxTyp))^{0.5}*V_{TP-SS})}

W_{P}/L_{P}=4*(W_{P1}/L_{P1})*[1+(((μCoxFF)/(μCoxTyp))^{0.5}−1)]*V_{GSP1}/{Vtpnom+((μCoxFF)/(μCoxTyp))^{0.5}*V_{TP-FF})

The current variation due to temperature is attributed to temperature dependence on mobility and threshold voltage. The temperature compensation principle is described as below, and can be expressed with respect to temperature as Equation (5):

μ=μ0/T^{1.5} and V_{T}=V_{T0}−(Svt)T

Where μ₀ and V_{T0} are the mobility and threshold voltage at absolute zero temperature and Svt is the slope factor. The equation for V_{GSP1} can be written as it is obtained from the PTAT reference as shown below in Equation (6):

V_{GSP1}=(R2/R1)K/qln(A1/A2)T

where A1 and A2 are the emitter area ratios for the bipolar junction transistors and R1 and R2 are resistors used for current reference. Putting Equations (5) and (6) into Equation (2) gives Equation 7:
I_{REF}((W_{REF}0**Cox)/(2*L_{REF}))*[(1−2*((W_{P1}*L_{P})/(W_{P}*L_{P1}))^{0.5})*(V_{TP}0)*T^{-0.75}−{(1−2((W_{P1}*L_{P})/(W_{P}/L_{P1}))^{0.5})*Svt−2((W_{P1}*L_{P})/(W_{P}*L_{P1}))^{0.5}*((R2/R1)*K/qln(A1/A2))}T^{0.25}]²

By keeping 2*((W_{P1}*L_{P})/(W_{P}*L_{P1}))^{0.5} to be close to 1 and less than 1, Equation (7) can be re-written as Equations (8) and (9):

I_{REF}=W_{REF}*μ₀*(Cox/2*L_{REF}))*([2((W_{P1}*L_{P})/(W_{P}*L_{P1}))^{0.5}*(R2/R1)K/qln(A1/A2))]²)T^{0.5}

I_{REF}=(W_{REF}*μ₀*Cox/(2*L_{REF}))*([(1−2((W_{P1}*L_{P})/(W_{P}*L_{P1}))^{0.5}*V_{TP})]²)*T^{-1.5}

Adding both Equation (8) and Equation (9) and equating its differential with respect to temperature to 0 yields Equation (10):

W_{P}/L_{P}=4*W_{P1}/L_{P1}*[1+(V_{GSP1}/((V_{TP}²+2V_{TP0*}V_{TP}))^{0.5}]²

The nominal value of V_{TP} can be used for calculating W₅/L in Equation (10). For V_{TPO}, the negative Vt slope can be estimated from simulations. Equations (10) and (4) are used for both temperature and process compensation. Tradeoffs can be made to nullify the temperature and process dependence of the reference current I_{REF} being generated with this principle. The 4 to 8 bits programmability can be incorporated for process and temperature compensation for the reference current being generated for process tuning.

The DC PSRR of the bandgap is maximized with the principle of employing a voltage subtractor circuit (whose output modulates the gates of current sources) to track the source node variations of PFET transistors used for the current source. In this manner, the supply noise gets cancelled at the bandgap reference output, maintaining a high DC PSRR. The PSRR variations with frequency gets determined through the operational amplifier unity gain bandwidth.

The bandgap reference output noise gets cancelled through an operational amplifier operated with chopper stabilization. For a low power operational amplifier, the accuracy is mainly impaired by the increased offset of the operational amplifier. The operational amplifier DC offset and 1/f noise gets significantly reduced through the use of a chopping mechanism.

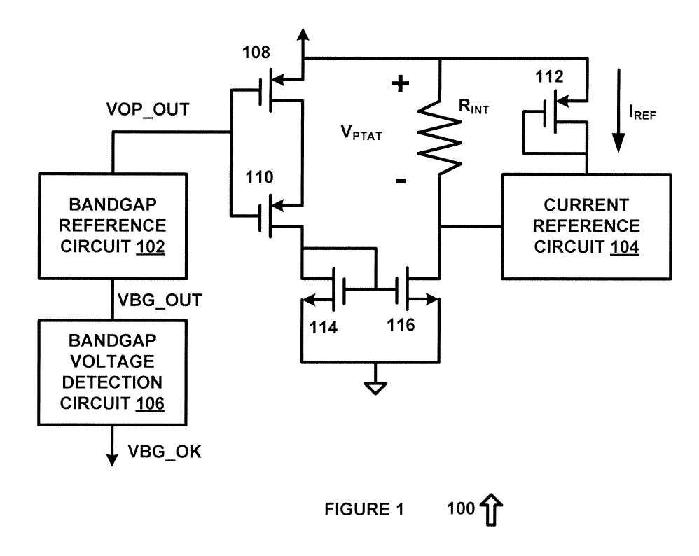

FIG. 1 is a diagram of a system 100 for providing a low power bandgap with current reference in a bandgap voltage detection circuit, in accordance with an exemplary embodiment of the present disclosure.

System 100 includes bandgap reference circuit 102, which generates a temperature-independent constant voltage having less variation as a function of process and voltage variations. The voltage difference is obtained between two diodes (which can be obtained using the base-emitter voltage drop V_{BE} of two bipolar junction transistors (BJTs) or in other suitable manners), where the two diodes are operated at different current densities. This voltage difference is used to generate a PTAT current in a first resistor. The PTAT current is used to generate a voltage in a second resistor that is added to the V_{BE} voltage of one of the junctions of the BJT. The voltage across a diode operated at constant current, such as the PTAT current, is complementary to absolute temperature (PTAT current reduces with increasing temperature, at approximately −2 mV/K). If the ratio between the first and second resistor is chosen properly, the first order effects of the temperature dependency of the diode and the PTAT current can cancel out.

Current reference 104 provides scaled currents to analog circuit components. The variation of this current across PVTs significantly affects the overall circuit performance. For internal resistor based current reference, the current varies as +/−20%, as the internal resistor varies with the same ratio. The internal resistance R_{INT} is used to produce V_{PTAT}, which serves as one of the factors determining the reference current I_{REF} to be compensated across PVTs.

Bandgap voltage detection circuit 106 circuit generates a VBG_OK signal whenever the bandgap voltage attains a predetermined value, such as 1.2 V.

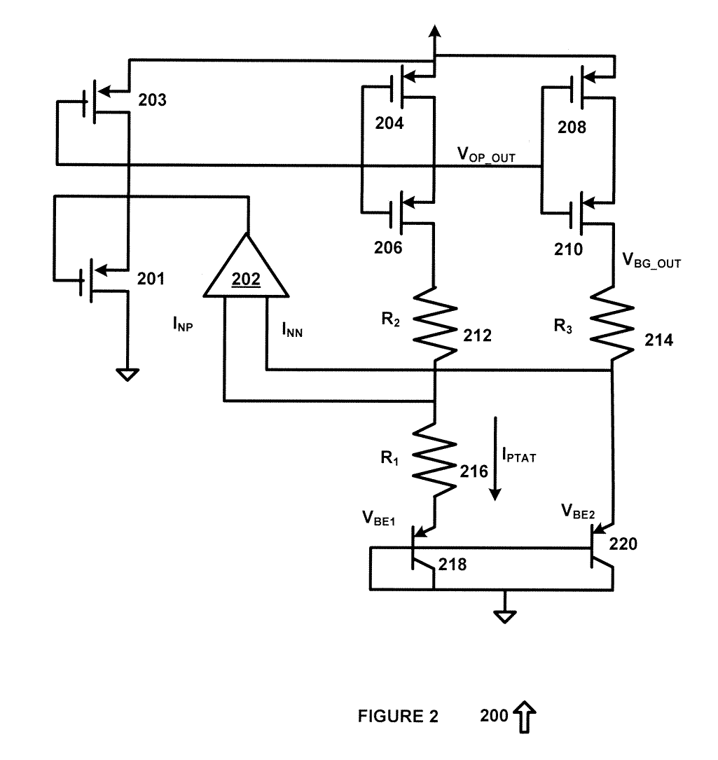

FIG. 2 is a diagram of a circuit 200 for generating a bandgap reference in accordance with an exemplary embodiment of the present disclosure. Based on the negative feedback configuration and a high open-loop gain of operational amplifier 202, the currents I_{NP} and I_{NN} will remain equal, such that

I_{PTAT}=(V_{BE2}−V_{BE1})/R1,

The variation of V_{BE2}−V_{BE1} is proportional to absolute temperature, where the current that flows through R1 is I_{PTAT}. The bandgap output voltage V_{BG}_{_{—}}_{OUT} is obtained as follows:

V_{BG}_{_{—}}_{OUT}=V_{BE2}+I_{PTAT}*R2=V_{BE2}+{(V_{BE2}−V_{BE1})*(R2 /R1)}

The absolute negative temperature coefficient variations of V_{BE2} get cancelled (first order) by I_{PTAT}*R2, so the bandgap output is rendered independent of temperature and is also compensated for process & voltage variations.

By choosing the a ratio of the emitter area for the bipolar junction transistors V_{BE1} and V_{BE2} to be 1:8, a PVT independent bandgap output with PTAT current is obtained.

The DC power supply rejection ratio (“PSRR”) of the bandgap is maximized by employing voltage subtractors 201 and 203, whose outputs modulate the gates of current sources, to track the source node variations of PFET transistors used for the current source. In this manner, the supply noise gets cancelled at the bandgap reference output, maintaining a high DC power supply PSRR. The PSRR variation as a function of frequency is determined by the operational amplifier unity gain bandwidth.

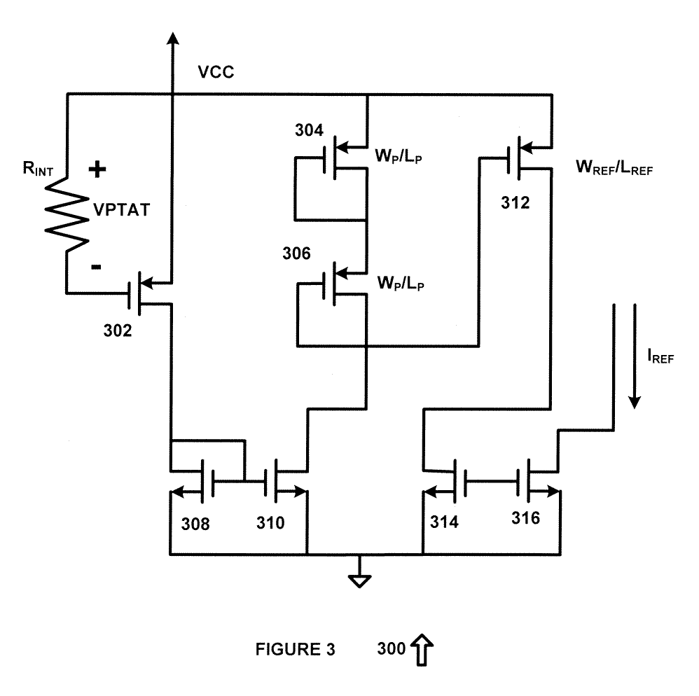

FIG. 3 is a diagram of a circuit 300 for generating a current reference in accordance with an exemplary embodiment of the present disclosure. In order to compensate for process variations where V_{GS-REP}=2*V_{GSP}, the reference current I_{REF} can be expressed as the following equation:

$$\begin{matrix}{I}_{REF} = μ Cox ( {W}_{REF} / ( 2 * {L}_{REF} ) ) * \\ [ \{ {( {V}_{TP} + 2 * {( ( 2 {I}_{P} ) / μ Cox * ( {W}_{P} / {L}_{P} ) )}^{0.5} ]}^{2} ] \\ = μ Cox ( {W}_{REF} / ( 2 * {L}_{REF} ) ) * \\ [ \begin{matrix}( 1 - 2 {( ( {W}_{P 1} / {L}_{P 1} ) / ( {W}_{P} / {L}_{P} ) )}^{0.5} * ( {V}_{TP} ) + \\ 2 {( ( {W}_{P 1} / {L}_{P 1} ) / ( {W}_{P} / {L}_{P} ) )}^{0.5} * ( {V}_{GSP 1} )\end{matrix} ]\end{matrix}$$

where V_{GS-REF} is obtained by using a cascaded configuration of two PMOS transistors having W_{P}/L_{P}. If the current I_{P} is obtained from a PMOS transistor having (W_{P1}/L_{P1}) with an NMOS current mirror, then the current I_{REF} can be expressed as

I_{REF}=μCox(W_{REF}/(2*L_{REF}))*[{1−2((W_{P1}/L_{P1})/(W_{P}/L_{P}))^{0.5}*(V_{TP})+2((W_{P1}/L_{P1})/(W_{P}/L_{P}))^{0.5}(V_{GSP1})}]

After differentiating I_{REF} with respect to μCox and equating to 0 for the reference current to be process compensated, the equation becomes:

μCox/μCox_{NOM}=[{1−2*((W_{P1}/L_{P1})/(W_{P}/L_{P}))^{0.5}*V_{TP-NOM}+2*((W_{P1}/L_{P1})/(W_{P}/L_{P}))^{0.5}* (V_{GSP1})]/[{1−2((W_{P1}/L_{P1})/(W_{P}/L_{P}))^{0.5}*V_{TP}+2((W_{P1}/L_{P1})/(W_{P}/L_{P}))^{0.5}*(V_{GSP1})]

μCox_{NOM} and V_{TP-NOM} are the nominal values of μCox and V_{TP} without any process variations. For a given current, the ratio of W_{P1/}L_{P1} can be calculated by setting V_{GSP1}=2*V_{TP-NOM}.

Similarly, for any two PVT corners (typically SS and FF), the ratio of (W_{P}/L_{P}) can be calculated as

W_{P}/L_{P}=4(W_{P1}/L_{P1})*[1+[(μCoxSS/μCoxTyp)^{0.5}−1}*V_{GSP1}]/[{V_{TP-NOM}−(μCoxSS/μCoxTyp)^{0.5}*V_{TP-SS}}]]

W_{P}/L_{P}=4(W_{P1}/L_{P1})*[1+[(μCoxFF/μCoxTyp)^{0.5}−1}*V_{GSP1}]/[{V_{TP-NOM}+(μCoxFF/μCoxTyp)^{0.5}*V_{TP-FF}}]]

The current variation due to temperature is attributed to temperature dependence on mobility and the threshold voltage. The temperature compensation principle can be expressed with respect to temperature as:

μ=μ₀/(T^{1.5}) and

V_{T}=V_{T0}−(S_{VT})*T

where μ₀ & V_{T0} are the mobility and threshold voltage at absolute zero temperature and S_{VT} is the slope factor.

The formula for V_{GSP1} can be written as it is obtained from the PTAT reference as:

V_{GSP1}=(R2/R1)(K/q)(ln(A1/A2)T

where A1 and A2 are the BJT emitter area ratio and R1 and R2 are resistors used for current reference. Trade-offs can be made nullify the temperature and process dependence of the reference current I_{REF} being generated. The N-bits programmability can be incorporated for process and temperature compensation for the reference current being generated, such as for process tuning.

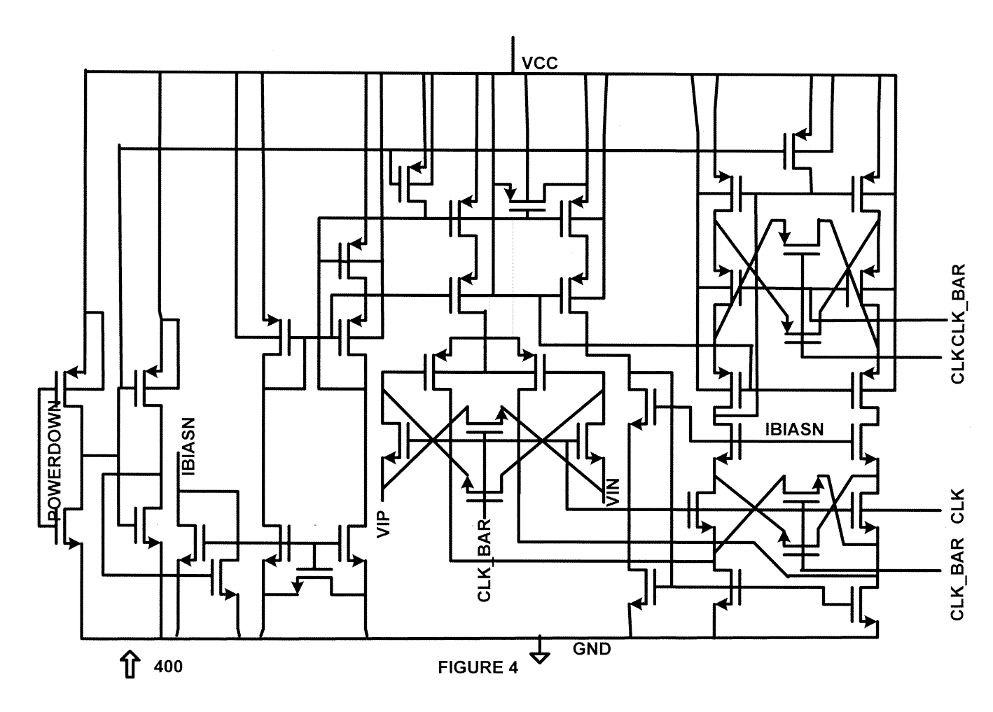

FIG. 4 is a diagram of a detection/monitoring circuit 400 for detecting the bandgap output and the bias current proportional to bandgap output VBG_OUT in accordance with an exemplary embodiment of the present disclosure. The detection threshold is determined through a capacitance formed by the current source transistor. The VBG_OK signal is detected and verified through power supply minimum ramp (such as from 0 to 20 us) to maximum ramp (such as from 0 to 1 ms). The POWER_DOWN signal enables or disables detection/monitoring circuit 400 depending on the requirement.

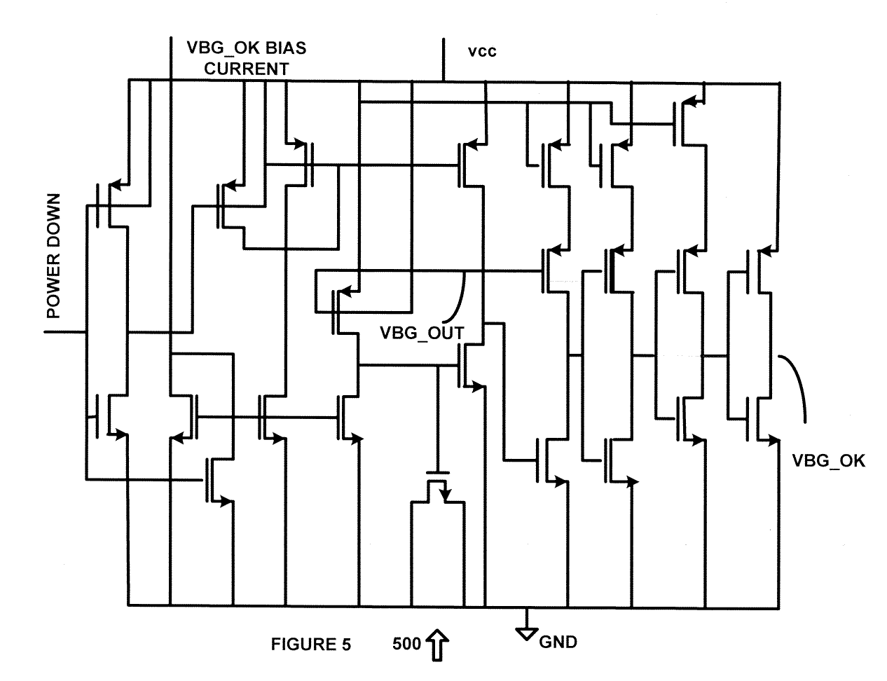

FIG. 5 is a diagram of an operational amplifier 500 with chopper stabilization for low noise in accordance with an exemplary embodiment of the present disclosure. Chopper stabilization pushes the 1/f noise to a high frequency band, where the noise gets filtered out by using a low-pass filter, such as a capacitor that is terminated at the operational amplifier output.

The offset between the input transistor pair gets cancelled out through the input chopper transistors that are driven by CLK and CLK_BAR clock signals. Similarly, additional chopper transistors cancel out the 1/f noise and offset produced by the current mirrors transistors. Overall noise and DC offset spread gets drastically reduced through the use of a chopper stabilization technique implemented at the input differential pair transistors and current mirrors. Operational amplifier 400 thus has a high open-loop gain and enough unity gain bandwidth for good DC PSRR and PSRR bandwidth.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for generating a bandgap and current reference comprising:
a bandgap reference circuit for generating a proportional first input after producing a bandgap reference voltage output;
a current reference circuit for receiving the proportional first input and a second input and generating a reference current therefrom; and
an internal resistor coupled to the bandgap reference circuit and the current reference circuit, wherein the proportional first input and the second input are generated as a function of the internal resistor.

2. The system of claim 1 further comprising a bandgap voltage detection circuit for receiving the bandgap reference voltage output and the reference current and for determining whether a bandgap voltage has attained a predetermined value.

3. The system of claim 1 further comprising a series connected transistor pair connected in parallel with the internal resistor.

4. The system of claim 1 further comprising a transistor connected in series with the internal resistor.

5. The system of claim 1 wherein the current reference circuit is connected in series with a transistor and the series-connected transistor and current reference circuit is connected in parallel with the internal resistor.

6. The system of claim 1 wherein the bandgap reference circuit further comprises an operational amplifier.

7. The system of claim 1 wherein the bandgap reference circuit further comprises an operational amplifier with chopper stabilization.

8. The system of claim 1 wherein the bandgap reference circuit further comprises one or more bipolar junction transistors.

9. The system of claim 1 wherein the bandgap reference circuit further comprises one or more bipolar junction transistors and one or more field effect transistors.

10. The system of claim 1 wherein the bipolar junction transistors are operated as diodes.

11. A system for generating a bandgap and current reference comprising:
a bandgap reference circuit for generating a bandgap reference voltage output and a proportional first input;
means for receiving a second input and generating a reference current; and
an internal resistor receiving the proportional first input from the bandgap reference circuit and the means for generating the reference current, wherein the reference current is a function of the internal resistor.

12. The system of claim 11 further comprising a bandgap voltage detection/monitoring circuit for receiving the bandgap reference voltage output and determining whether a bandgap voltage has attained a predetermined value.

13. The system of claim 11 further comprising a series connected transistor pair connected in parallel with the internal resistor.

14. The system of claim 11 further comprising a transistor connected in series with the internal resistor.

15. The system of claim 11 wherein the bandgap reference circuit further comprises an operational amplifier.

16. The system of claim 11 wherein the bandgap reference circuit further comprises an operational amplifier with chopper stabilization.

17. The system of claim 11 wherein the bandgap reference circuit further comprises one or more bipolar junction transistors.

18. The system of claim 11 wherein the bandgap reference circuit further comprises one or more bipolar junction transistors and one or more field effect transistors.

19. The system of claim 11 wherein the bipolar junction transistors are operated as diodes.

20. A system for generating a bandgap and current reference comprising:
a bandgap reference circuit for generating a first input and a bandgap reference voltage output;
a current reference circuit for receiving a second input and generating a reference current;
an internal resistor coupled to the bandgap reference circuit and the current reference circuit, wherein the reference current is generated as a function of the internal resistor, the first input and the second input;
a bandgap voltage detection circuit for receiving the bandgap reference voltage output and determining whether a bandgap voltage has attained a predetermined value;
a series connected transistor pair connected in parallel with the internal resistor;
a parallel-connected transistor pair connected in series with the internal resistor and the series connected transistor pair;
wherein the current reference circuit is connected in series with a transistor and the series-connected transistor and current reference circuit is connected in parallel with the internal resistor;
wherein the bandgap reference circuit further comprises:
an operational amplifier with chopper stabilization;
one or more bipolar junction transistors;
one or more field effect transistors; and
wherein the bipolar junction transistors are operated as diodes.
